(19) United States
(12) Patent Application Publication
(10) Pub. No.: US 2019/0082901 A1
(43) Pub. Date: Mar. 21, 2019

(54) GLASS CLEANER

(71) Applicant: Huizhou Duran Creative Technology Co. ,Ltd., Huizhou (CN)

(72) Inventors: Qiuping Liu, Huizhou (CN); Juan Jose Duran Lopez, Huizhou (CN)

(21) Appl. No.: 15/818,238

(22) Filed: Nov. 20, 2017

(30) Foreign Application Priority Data
Sep. 18, 2017 (CN) 201721198971.7

(51) Int. Cl. A47L 1/06; B25G 1/04; B25G 3/38

(52) U.S. Cl. CPC A47L 1/06; B25G 3/38; B25G 1/04

(57) ABSTRACT

A glass cleaner includes a hand-held rod and a cleaning frame mounted at the end of the hand-held rod. The cleaning frame is provided with at least two parallel and spaced scraping strips. Both the front and rear ends of a connection portion between the hand-held rod and the cleaning frame are provided with the scraping strips.

### TECHNICAL FIELD

The present application relates to the technical field of cleaning tools, and more particularly to a glass cleaner.

### BACKGROUND

Glass cleaner is used to clean glass. An existing glass cleaner usually cleans glass by a scraping strip or scraping slice, which is difficult to clean up by scraping only once, and scraping again may make smudges be dispersed on the glass, thereby affecting the cleaning effect. The scraping strip needs to be cleaned by cloth before repeated scraping, which is time-consuming and laborious. In addition, the power application and angle control of the existing glass cleaner is realized by the operator's arm, when cleaning glass at a high position, it is difficult to ensure a close contact between the scraping strip and the glass and the angle control, thereby affecting the cleaning efficiency and effectiveness.

### SUMMARY

The object of the present application is to provide a glass cleaner, so as to solve the problem of low glass cleaning efficiency and poor cleaning effect in the prior art.

In order to achieve the above object, the technical solution of the application is: providing a glass cleaner comprising a hand-held rod and a cleaning frame mounted at an end of the hand-held rod, wherein the cleaning frame is provided with at least two parallel and spaced scraping strips, and both the front and rear ends of a connection portion between the hand-held rod and the cleaning frame are provided with the scraping strips, each of the scraping strips is perpendicular to an axial direction of the hand-held rod.

Further, a plurality of rollers for running on the glass are rotatably provided on the cleaning frame, each of the rollers is arranged on the same side of the cleaning frame as each of the scraping strips and is axially parallel to the scraping strips.

Further, both ends of the cleaning frame are respectively provided with at least two of the rollers, and the rollers at each end of the cleaning frame are arranged in a width direction of the cleaning frame.

Further, at least two of the rollers are respectively attached to the two ends of the cleaning frame, and the rollers at each ends of the cleaning frame are arranged in a width direction of the cleaning frame.

Further, the cleaning frame is rotatably connected to the hand-held rod, and the cleaning frame is provided with a rotating shaft configured for connecting the hand-held rod so that the cleaning frame can be turned by 360 degrees on the hand-held rod, and the axial direction of the rotating shaft is parallel to the axial direction of the roller.

Further, the end of the hand-held rod is provided with a connecting plate, and the rotating shaft is fixed to the connecting plate.

Further, the hand-held rod is connected to the connecting plate via a pivot, and the pivot is perpendicular to the axis of rotating shaft.

Further, support plates are respectively provided on both sides of the cleaning frame, each of the support plates is connected to a side of the cleaning frame via a connecting shaft, the cleaning frame is provided with a first spring configured for pushing each of the connecting shafts, each of the support plates is provided with hooks configured for connecting the scraping strip mount, and each of the scraping strip mounts is provided with hook holes configured for connecting corresponding hooks on the both support plates respectively.

Further, a cross-section of each of the hooks is circular or semicircular, the cleaning frame is provided with an elastic telescopic rod configured for rebutting against the scraping strip, and the scraping strip mount defines an opening at a position corresponding to the elastic telescopic rod.

Further, each of the scraping strip mounts is provided with a dovetail groove or a T-groove, and each of scraping strips is correspondingly provided with a wing-shaped connector, each of the wing-shaped connector is configured to insert into the dovetail groove or a T-groove of a corresponding one of the scraping strip mounts.

The advantages of the glass cleaner provided by the present application include: compared with the prior art, when the glass cleaner of the present application is cleaning glass, since each of the scraping strips can be in contact with the glass and form multiple cleaning operations, the condition of repeating cleaning by one scraping strip is avoid; with respect to the cleaning line, the front ones of the scraping strips are used for cleaning, and the rear ones of the scraping strip are used for further cleaning, decontamination and polishing, so as to complete the cleaning work easily and quickly. The glass cleaner provided by the present application could complete the glass cleaning work by only once operation, and thus improves the work efficiency and cleaning effect effectively. Furthermore, the glass cleaner provided by the present application which allows the user to complete a one-time cleaning from the top of the surface of the glass to its bottom while maintaining a correct back posture, thereby preventing the elders from causing damage due to improper movements, and this is also suitable for people suffering from sciatica or pregnant people.

### BRIEF DESCRIPTION OF THE DRAWINGS

In order to illustrate the technical solution in the embodiments of the present application more clearly, the drawings to be used in the embodiments or in the prior art will be briefly described below, obviously, the drawings in the following description are merely embodiments of the present application, and other drawings could be obtained based on these drawings by those skilled in the art without paying any creative work.

FIG. 1 is a first schematic view of a structure of a glass cleaner provided by an embodiment of the present application;

FIG. 2 is a second schematic view of a structure of the glass cleaner provided by the embodiment of the present application;

FIG. 3 is a first exploded structural view of the glass cleaner provided by the embodiment of the present application;

FIG. 4 is a second exploded structural view of the glass cleaner provided by the embodiment of the present application;

FIG. 5 is a sectional view of a cleaning frame of the glass cleaner provided by the embodiment of the present application;

FIG. 6 is a schematic front view of the glass cleaner provided by the embodiment of the present application;

FIG. 7 is a schematic side view of the glass cleaner provided by the embodiment of the present application.

### DETAILED DESCRIPTION OF THE EMBODIMENTS

In order to make the purposes, technical solutions, and advantages of the present application be clear, the present application will be further described in detail hereinafter with reference to accompanying drawings and embodiments. It should be understood that the specific embodiments described herein are merely intended to explain but not to limit the present application.

It should be noted that when an element is referred to as being “fixed” or “disposed” on another element, it may be directly on the other element or indirectly on the other element. When an element is referred to as being “connected” to another element, it may be directly connected to another element or indirectly connected to the other element.

In the description of the present application, it should be understood that the azimuth or positional relationship indicated by terms “length”, “width”, “up”, “low”, “front”, “rear”, “left”, “right”, “vertical”, “horizontal”, “top”, “bottom”, “inside”, “outside” and so on are based on the azimuth or positional relationship shown in the drawings, which is used to facilitate the description of the present application and simplify the description rather than indicate or imply that the device or element must have a specific orientation, constructed and operated in a particular orientation, and therefore should not be construed as limits of the present application.

In addition, the terms “first” and “second” are only used for illustrating, and should not be construed as indicating or imposing a relative importance or implicitly indicating the number of the indicated technical features. Thus, a feature that defined by “first” or “second” could expressly or implicitly includes one or more of the features. In the description of the present application, the meaning of “plural” is two or more, unless specifically defined.

In the present application, unless specifically defined, the terms “install”, “connected”, “connected to”, “fixed” and the like should be understood in a broad sense, for example, it can be a fixed connection, a removable connection, or an one-piece molding structure; it can be a mechanical connection or an electrical connection; it can be direct connection or be indirect connection through an intermediary, and also can be an internal connection between two components or an interaction relationship between two components. It will be apparent to those skilled in the art to understand the specific meaning of the above-mentioned term in the present application based on specific situation.

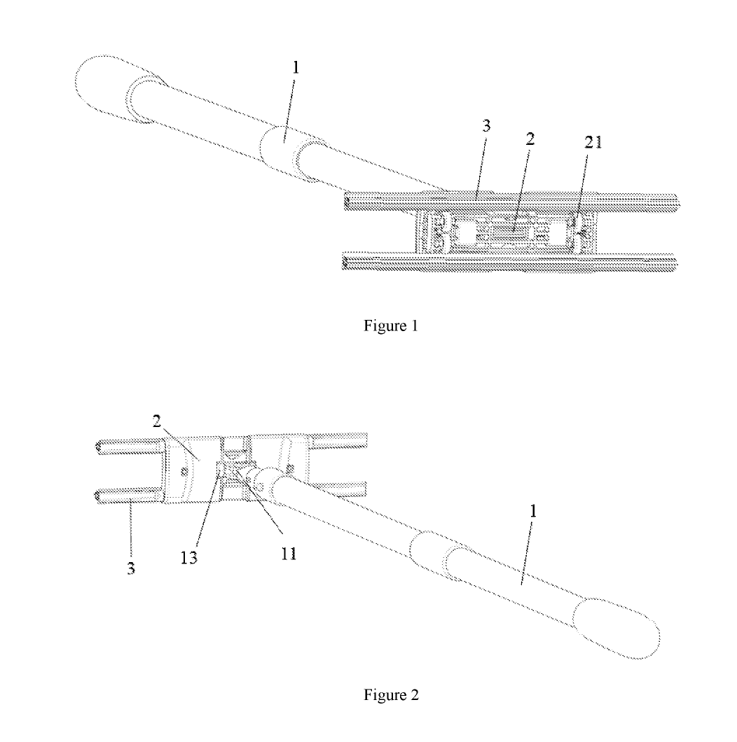

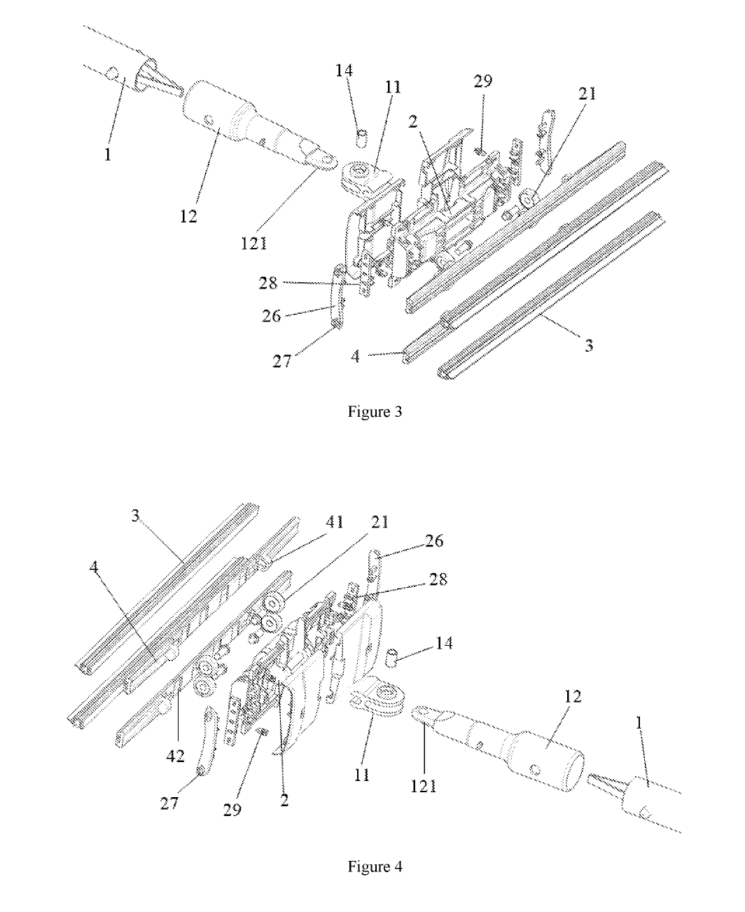

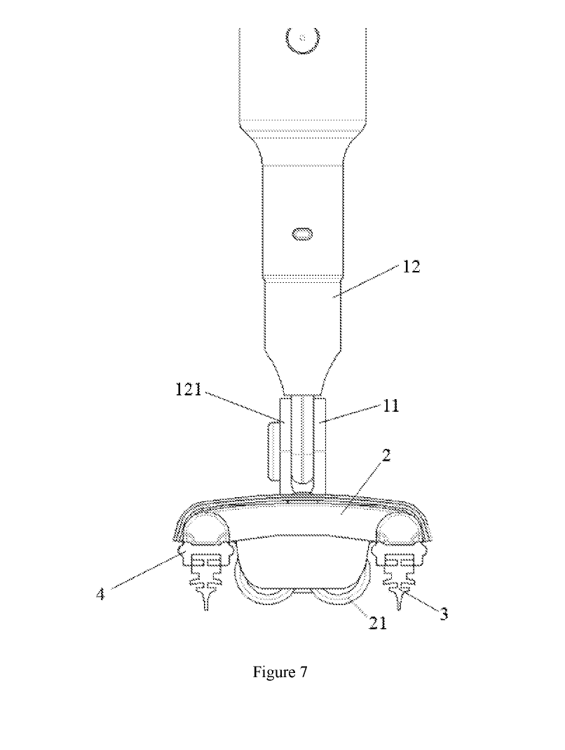

Referring to FIGS. 1 and 7, a glass cleaner provided in the present application is described below. The glass cleaner comprises a hand-held rod 1 and a cleaning frame 2 mounted at one end of the hand-held rod 1, the cleaning frame 2 is provided with at least two scraping strips 3, the scraping strips 3 are arranged in parallel and spacedly; each of the scraping strips 3 is perpendicular to an axial direction of the hand-held rod 1, and both front and rear ends of a connection portion between the hand-held rod 1 and the cleaning frame 2 are provided with the scraping strips 3. When the glass cleaner of the present application is cleaning glass, since each of the scraping strips 3 can be in contact with the glass and form multiple cleaning operation, the condition of repeating cleaning by one scraping strip 3 is avoid. The glass cleaner provided by the present application could complete the glass cleaning work by only once operation, and thus improve the work efficiency and cleaning effect effectively. In this embodiment, as shown in FIGS. 2 and 3, the cleaning frame 2 is in a plate-type structure, and each of the scraping strip 3 is mounted on a plate surface of a corresponding side of the cleaning frame 2; in this embodiment, the number of the above-mentioned scraping strip 3 is two, so that the required glass cleaning effect and efficiency can be ensured. In other embodiments, the number of the scraping strip 3 could also be three, four, and others.

Compared with the prior art, when the glass cleaner of the present application is cleaning glass, since each of the scraping strips can be in contact with the glass and form multiple cleaning operations, the condition of repeating cleaning by one scraping strip is avoid; with respect to the cleaning line, the front ones of the scraping strip is used for cleaning, and the rear ones of the scraping strips are used for further cleaning, decontamination and polishing, so as to complete the cleaning work easily and quickly. The glass cleaner provided by the present application could complete the glass cleaning work by only once operation, and thus effectively improves the work efficiency and cleaning effect.

Further, referring to FIGS. 1 to 4, as a specific embodiment of the glass cleaner provided by the present application, a plurality of rollers 21 for running on the glass are rotatably provided on the cleaning frame 2, each of the rollers 21 is arranged on the same side of the cleaning frame 2 as each of the scraping strips 3, and their axial directions are all parallel to the scraping strips 3. Undoubtedly, the distance of the rollers 21 protruding from the cleaning frame 2 is preferably slightly smaller than the distance of the scraping strips 3 protruding from the cleaning frame 2, so as to ensure that each scraping strips 3 can be effectively contacted with the glass, at the same time, each roller 21 is able to be in rolling contact with the glass. Of course, this can be reasonably designed according to the degree of flexibility of the scraping strips 3, and is readily achievable by those skilled in the art; the distance protruding from cleaning frame 2 is the distance from an end of the corresponding member away from the cleaning frame 2 to the cleaning frame 2. By providing the roller 21, it is ensured that the force application is convenient when cleaning the glass, and the event that the scraping strips 3 is subjected to excessively squeezing, so that a hard material member such as the cleaning frame 2 contacts with the glass and causes damage of the glass is avoided. Further, it is possible to ensure an effective contact of the cleaning frame 2 with the glass, so that it is easy to operate when cleaning the glass at a high position. At the same time, the structure is easy to roll back and forth when cleaning, which is easy to clean quickly.

Further, as a specific embodiment of the glass cleaner provided by the present application, a plurality of rollers 21 are arranged on the cleaning frame 2; in the present embodiment, the number of the rollers 21 is four.

Further, as a specific embodiment of the glass cleaner provided by the present application, two ends of the cleaning frame 2 are respectively provided with at least two of the rollers 21, so that the roller s21 can be better provided the support function and thereby facilitate scraping. The rollers 21 at each end of the cleaning frame 2 are arranged in the width direction of the cleaning frame 2, in this way, by providing a plurality of rollers 21, the roller 21 could support the cleaning frame 2 on the glass when scraping back and forth, thereby facilitating scratching and cleaning.

Further, the cleaning frame 2 is rotatably connected to the hand-held rod 1, and the hand-held rod 1 is provided with a rotating shaft 13, the rotating shaft 13 is connected to the cleaning frame 2, so that the cleaning frame 2 and the hand-held rod 1 can be turned by 360 degrees, which allows the user to complete a one-time cleaning from the top of the surface of the glass to its bottom while maintaining a correct back posture, thereby preventing the elders from causing damage due to improper movements, and this is also suitable for people suffering from sciatica or pregnant people.

Further, referring to FIG. 3, as a specific embodiment of the glass cleaner provided by the present application, the end portion of the hand-held rod 1 is provided with a connecting plate 11, the rotating shaft 13 is fixed to the connecting plate 11. The connecting plate 11 is provided so as to connect the rotary shaft 13 with the hand-held rod 1.

Further, as a specific embodiment of the glass cleaner provided by the present application, the hand-held rod 1 is connected to the connecting plate 11 via a pivot 14, the pivot 14 is perpendicular to the axis of rotating shaft 13. This structure enables a 360 degree rotation between the connecting plate 11 and the cleaning frame 2, and the hand-held rod 1 and the connecting plate 11 can be relatively rotated; since the pivot 14 is perpendicular to the rotary shaft 13, it is possible to realize a rotation with any degree in the space, so that the user can clean the glass surface at any angle and direction while maintaining a correct back posture, thereby preventing the elders from causing damage due to improper movements, and this is also suitable for people suffering from sciatica or pregnant people.

Further, as a specific embodiment of the glass cleaner provided by the present application, the end of the hand-held rod 1 is provided with a flat plate 121, and the connecting plate 11 is provided with a receptacle, the flat plate is inserted into the receptacle, and the side walls of the receptacle are connected to the flat plate by the pivot 14, so as to realize a connection of the handle rod 1 with the connecting plate 11. This structure can facilitate the connection between the hand-held rod 1 and the connecting plate 11 and thereby improve the connection strength.

Further, the end of the hand-held rod 1 is detachably connected with a connector 12, and the flat plate 121 is disposed on the connector 12. The connector 12 is provided to facilitate the disassembly and reduce the occupied space.

Further, referring to FIGS. 1, 3 and 4, as a specific embodiment of the glass cleaner provided by the present application, each of the scraping strip 3 is attached to the cleaning frame 2 through a scraping strip mount 4 and is detachably connected to the corresponding one of the scraping strip mounts 4. That is, the scraping strip mounts 4 supporting the scraping strips 3 are detachably attached to the cleaning frame 2, and each of the scraping strip 3 is detachably mounted on a corresponding one of the scraping strip mounts 4, so that it is easy to replace the scraping strip 3. Each of the scraping strip mount 4 is mounted on the cleaning frame 2, preferably in a form of snap-in. A conventional detachable connection can be used between the scraping strip 3 and the scraping strip mount 4, as shown in FIG. 4, as a specific embodiment, the scraping strip mount 4 is provided with a dovetail groove or a T-groove, and the scraping strip 3 is provided with a wing-shaped connector 31 correspondingly. A detachable mounting of the scraper 3 can be realized by inserting the wing-shaped connector 31 into the dovetail groove or a T-groove on the scraping strip mount 4, so that the scraping strip 3 can clean the glass in both directions. The scraping strip mount 4 can also be detached for easy cleaning.

Further, support plates 26 are respectively provided on both sides of the cleaning frame 2, each of the support plates 26 is connected to a side of the cleaning frame 2 by a connecting shaft 28; the cleaning frame 2 is provided with a first spring (not shown in the Figures) for pushing each of the connecting shafts 28, each of the support plates 26 is provided with hooks 27 for connecting the scraping strip mount 4, each of the scraping strip mount 4 is provided with hook holes for connecting the corresponding hooks 27 on the two support plates 26 respectively. The support plate 26 is mounted on the cleaning frame 2 via the connecting shafts 28, and a first spring is mounted on the cleaning frame 2 to abut against the connecting shaft 28 and can further push the support plate 26 outwardly, so as to make the support plate 26 on both sides of the cleaning frame 2 move away. In this way, when the scraping strip mount 4 is mounted, the two support plates 26 can be pressed inward, so that the hooks 27 thereon are close to each other so as to mount the scraping strip mount 4 on the cleaning frame 2, the structure allows for easy installation of the scraping strip mount 4. In other embodiments, a hook can also be provided directly on the cleansing frame 2 to engage the scraping strip mount 4.

Further, a cross-section of each hooks 27 can be circular or semicircular, so that the scraping strip mount 4 can swing by a certain angle relative to the cleansing frame 2; further, in a back and forth scraping, the cleansing frame 4 drives the scraping strip 3 to swing so that the scraping strip 3 is in a good seamless contact with the glass and thereby makes the cleaning be simpler and cleaner.

Further, the cleaning frame 2 is provided with an elastic telescopic rod 29 for abutting the scraping strip 3, and a position of each scraping strip mount 4 corresponding to the elastic telescopic rod 29 defines an opening 42, the free end of the elastic telescopic rod 29 extends and passes through the opening 42 and abut against the bottom surface of the scraping strip 3. An elastic telescopic rod 29 is provided on the cleaning frame 2, so that it is possible to abut against the scraping strip 3 by the elastic telescopic rod 29 so as to provide an elastic buffer effect, thereby adjusting the pressure of the scraping strip 3 against the glass during scraping. That is, intensity of scraping can be adjusted to make it easier to scrap and clean. At the same time, during the back and forth scraping, the elastic telescopic rod can swing relative to the arc groove; further, during the back and forth scraping, the scraping strip mount 4 can swing by a certain angle relative to the cleaning frame 2 and further drive the scraping strip 3 to swing, so that the scraping strip 3 can be in a better contact with the glass, thereby making the cleaning be easier and cleaner. Of course, in other embodiments, an arc groove correspond, so that the free end of the elastic telescopic rod 29 abuts against the bottom surface of the arc groove.

Further, the elastic telescopic rod 29 includes a connecting rod slidably mounted on the cleaning frame 2 and a second spring pushing the connecting rod. The connecting rod is pushed through the second spring to form an elastic telescopic rod structure. Of course, in other embodiments, other structures may be used, for example, a telescopic rod structure is used, and a spring is provided in the telescopic rod to form an elastic telescopic rod structure.

Further, referring to FIG. 4, as a specific embodiment of the glass cleaner provided by the present application, a plurality of the wing-shaped connectors 31 are provided successively on the scraping strip 3 along the height direction thereof, on one hand, when a lower wing-shaped connectors 31 is damaged, it can be cut off, and thus the wing-shaped connectors 31 above it can be used, thereby extending the service life of the scraping strip 3; on the other hand, the number of edges of the scraping strip 3 can be increased, since the cleaning effect is better when the edges contact with glass, the cleaning effect of the glass cleaner can be effectively improved; in addition, this structure also causes the scraping strip 3 to have a certain hollowing ratio, that is, improves the deformability of the scraping strip 3, thereby increasing the contact area with the glass, enhance the cleaning effect.

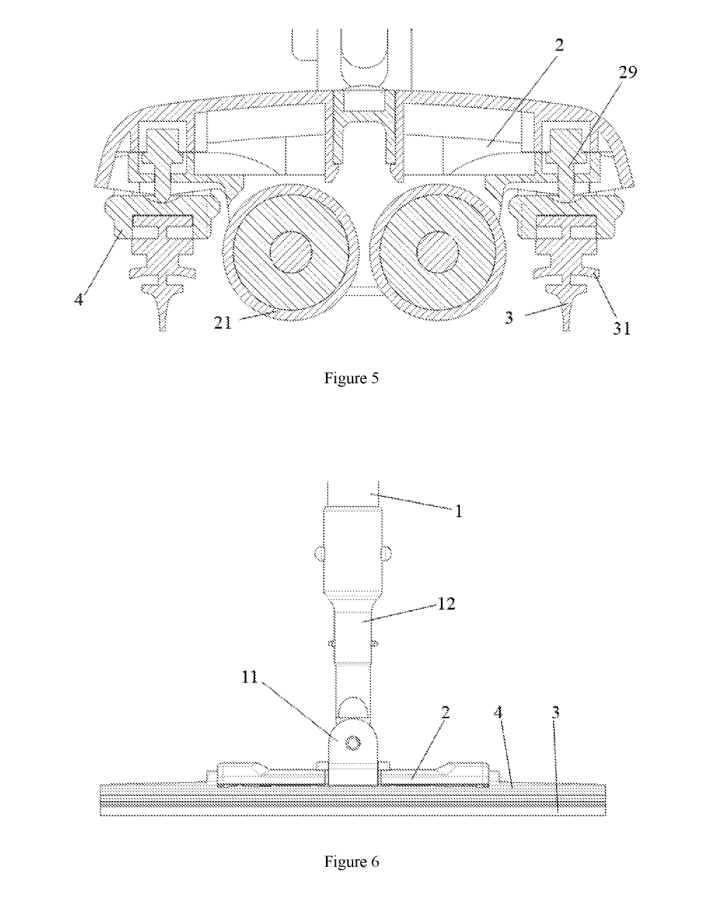

Further, referring to FIG. 5, as a specific embodiment of the glass cleaner provided by the present application, the scraping strip mount 4 is provided with a slot 40, the wing-shaped connectors 31 at the bottom of the scraping strip 3 can be inserted into the slot 40 of the scraping strip mount 4 so as to facilitate the mounting of the scraping strip 3 into the scraping strip mount 4, the mounting is easy and it is also easy to disassemble.

Further, as a specific embodiment of the glass cleaner provided by the present application, the hand-held rod 1 is a telescopic rod so as to facilitate the adjustment of the length and make it easy to clean.

Further, as a specific embodiment of the glass cleaner provided by the present application, the cleaning frame 2 also includes a fixed housing 20 so as to increase the strength of the cleaning frame 2 and improve its using life.

Further, as a specific embodiment of the glass cleaner provided by the present application, the scraping strips 3 are arranged in a symmetrical structure along a middle plane of the longitudinal direction thereof, so as to move back and forth in both directions and thereby ensure that the scraping strip 3 is in contact with the glass in order to clean the glass quickly.

The glass cleaner provided by the present application is provided with a plurality of scraping strips 3 arranged in parallel, during cleaning, the front ones of the scraping strips 3 can clean the glass, and the rear ones of the scraping strips 3 can further clean, decontaminate, and polish, so as to complete the cleaning work easily and quickly. The rollers 21 are provided on the cleaning frame 2 so as to roll on the glass when cleaning the glass, which is more convenient for the scraping strips 3 to move on the glass. The plurality of wing-shaped connectors 31 provided on the scraping strips 3 can extend the using life of the cleaner. The scraping strips 3 are in a symmetrical structure and is convenient to move back and forth to clean the glass. An elastic telescopic rod abutting against the glass provided on the cleaning frame can adjust the strength of the scraping strips against the glass, and can also enable the scraping strips to swing in a certain extent so as to perform a better cleaning. The hand-held rod 1 is pivoted to the cleaning frame 2 via the connecting plate 11, so that the cleaning frame 2 can be turned by 360 degrees on the hand-held rod 1, and thus the user can clean the glass surface at any angle and direction while maintaining a correct back posture, thereby preventing the elders from causing damage due to improper movements, this is also suitable for people suffering from sciatica or pregnant people. Designing the hand-held rod 1 as a telescopic rod can facilitate the adjustment of the length and is easy to clean.

The foregoing descriptions are merely exemplary embodiment of the present application, but are not intended to limit the present application. Any modification, equivalent replacement, or improvement made without departing from the spirit and principle of the present application shall fall within the protection scope of the present application.

What is claimed is:

1. A glass cleaner, comprising a hand-held rod and a cleaning frame mounted at an end of the hand-held rod; wherein the cleaning frame is provided with at least two parallel and spaced scraping strips, and both the front and rear ends of a connection portion between the hand-held rod and the cleaning frame are provided with the scraping strips.

2. The glass cleaner according to claim 1, wherein, a plurality of rollers for running on the glass are rotatably provided on the cleaning frame, each of the rollers is arranged on the same side of the cleaning frame as each of the scraping strips and is axially parallel to the scraping strips.

3. The glass cleaner according to claim 2, wherein both ends of the cleaning frame are respectively provided with at least two of the rollers, and the rollers at each end of the cleaning frame are arranged in a width direction of the cleaning frame.

4. The glass cleaner according to claim 1, wherein, the cleaning frame is rotatably connected to the hand-held rod, and the cleaning frame is provided with a rotating shaft configured for connecting with the hand-held rod so that the cleaning frame can be turned by 360 degrees on the hand-held rod, and the axial direction of the rotating shaft is parallel to the axial direction of the roller.

5. The glass cleaner according to claim 4, wherein, the end of the hand-held rod is provided with a connecting plate, and the rotating shaft is fixed to the connecting plate.

6. The glass cleaner according to claim 5, wherein, the hand-held rod is connected to the connecting plate via a pivot, and the pivot is perpendicular to the axis of rotating shaft.

7. The glass cleaner according to claim 1, wherein: scraping strip mounts supporting the scraping strip are detachably mounted on the cleaning frame, and each of the scraping strip is detachably mounted on a corresponding one of the scraping strip mounts.

8. The glass cleaner according to claim 7, wherein, support plates are respectively provided on both sides of the cleaning frame, each of the support plates is connected to a side of the cleaning frame via a connecting shaft, the cleaning frame is provided with a first spring configured for pushing each of the connecting shafts, each of the support plates is provided with a hooks configured for connecting the scraping strip mount, and each of the scraping strip mounts is provided with hook holes configured for receiving corresponding hooks on the both support plates respectively.

9. The glass cleaner according to claim 7, wherein: a cross-section of each of the hooks is circular or semicircular, the cleaning frame is provided with an elastic telescopic rod configured for rebutting against the scraping strip, and the scraping strip mount defines an opening at a position corresponding to the elastic telescopic rod.

10. The glass cleaner according to claim 7, wherein: each of the scraping strip mounts is provided with a dovetail groove or a T-groove, and each of the scraping strips is correspondingly provided with a wing-shaped connector, each of the wing-shaped connectors is configured to insert into the dovetail groove or T-groove of a corresponding one of the scraping strip mounts.
